(19) United States
(12) Patent Application Publication
(10) Pub. No.: US 2026/0095790 A1
(43) Pub. Date: Apr. 2, 2026

(54) METHODS TO HANDLE AIML COMPLEXITY FOR MULTIPLE LCM FUNCTIONS

(71) Applicant: InterDigital Patent Holdings, Inc., Wilmington, DE (US)

(72) Inventors: Anouar Yatribi, Greater London (GB); Yugeswar Deenoo Narayanan Thangaraj, Chalfont, PA (US); Mihaela Beluri, Jericho, NY (US); Mohamed Salah Ibrahim, Chesterbrook, PA (US)

(73) Assignee: InterDigital Patent Holdings, Inc., Wilmington, DE (US)

(21) Appl. No.: 18/901,919

(22) Filed: Sep. 30, 2024

(51) Int. Cl. H04W 24/10; H04B 7/06; H04W 24/02

(52) U.S. Cl. CPC H04W 24/10; H04B 7/0626; H04W 24/02

(57) ABSTRACT

A WTRU may receive configuration information that indicates the WTRU is to perform a plurality of LCM functions. Each LCM function may be associated with AI/ML functionality of one or more AI/ML models operated by the WTRU. The WTRU may determine a plurality of measurement reports associated with a reporting occasion based on the configuration information. Each measurement report of the plurality of measurement reports may be associated with at least one LCM function of the plurality of LCM functions. The WTRU may determine a priority of each LCM function of the plurality of LCM functions based on the configuration information. The WTRU may determine a subset of measurement reports to include in a transmission for the first reporting occasion based on the priority of each LCM function of the plurality of LCM functions. The WTRU may send the subset of measurement reports in the transmission for the reporting occasion.

### BACKGROUND

One or more LCM functions may include: model activation/deactivation, training/retraining, fine-tuning, model switching, inference, performance monitoring, model selection, and/or the like.

### SUMMARY

A wireless transmit/receive unit (WTRU) supporting artificial intelligence (AI)/machine learning (ML) model(s) for one or more use-cases may handle collisions between one or more life cycle management (LCM) by determining the priority order of each LCM function(s) as a function of the AI/ML model complexity, available resources in terms of number of unoccupied processing units (PUs) and/or other complexity metric(s), measured applicable condition(s), and/or model performance. A WTRU may schedule the LCM function(s) in function of the determined priority order.

A WTRU may be triggered to transmit LCM collision report based on condition(s) associated with PU resources and/or uplink (UL) resources and/or type and/or number of LCM functions.

A WTRU may receive configuration information. The configuration information may indicate that the WTRU is to perform a plurality of LCM functions. The configuration information may include configuration for measurement reporting, configuration for AI/ML model monitoring, configuration for LCM function prioritization, and/or configuration for LCM function collision reporting. Each LCM function of the plurality of LCM functions may be associated with AI/ML functionality of one or more AI/ML models operated by the WTRU. The WTRU may determine a plurality of measurement reports associated with a first reporting occasion based on the configuration information. Each measurement report of the plurality of measurement reports may be associated with at least one LCM function of the plurality of LCM functions. The WTRU may determine a priority of each LCM function of the plurality of LCM functions based on the configuration information. The WTRU may determine a subset of the plurality of measurement reports to include in a transmission for the first reporting occasion based on the priority of each LCM function of the plurality of LCM functions. The WTRU may send the subset of measurement reports in the transmission for the first reporting occasion. Sending the subset of measurement reports may include sending one or more channel state information (CSI) measurements.

The plurality of LCM functions may include any combination of inference, data collection, training, fine-tuning, performance monitoring, model transfer, model selection, model activation/deactivation, and/or model switching. The WTRU may determine the priority of each LCM function based on one or more rules. The one or more rules may include a measurement priority, a LCM function priority, and/or a number of processing units (PUs). The measurement priority may be based on one or more of a measurement report type, a measurement report quantity, a serving cell index, and/or a report configuration. The LCM function priority may include a weighted LCM function, a weighted model performance, and/or a weighted applicable condition.

Determining the subset of the plurality of measurement reports may include dropping one or more measurements, for example, based on the determined priority of each LCM function and/or the configuration information. The WTRU may send a report that indicates AI/ML capability to the WTRU. The WTRU may transmit a LCM collision report. The LCM collision report may include an indication of one or more dropped LCM functions.

The WTRU may determine a priority order associated with the subset of the plurality of measurement reports. Determining the priority of each LCM function is based on the determined priority order associated with the subset of the plurality of measurement reports.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

### DETAILED DESCRIPTION

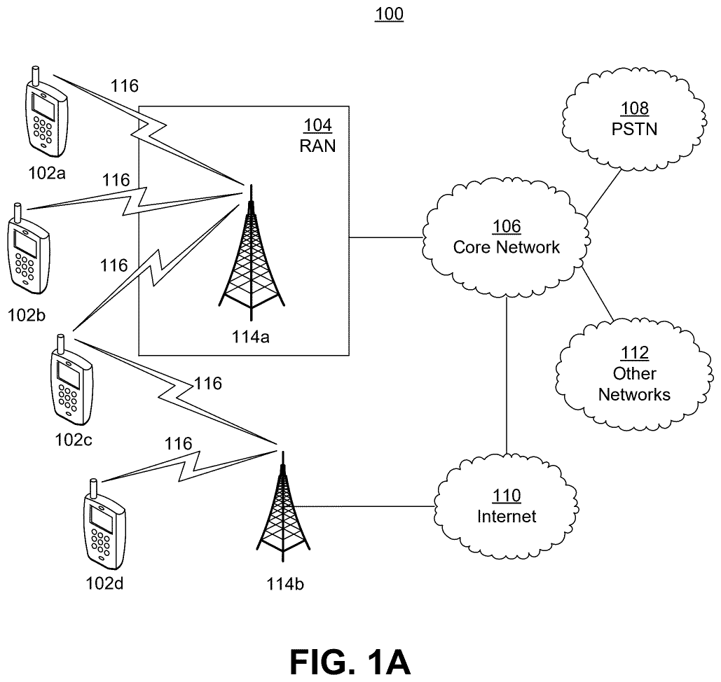

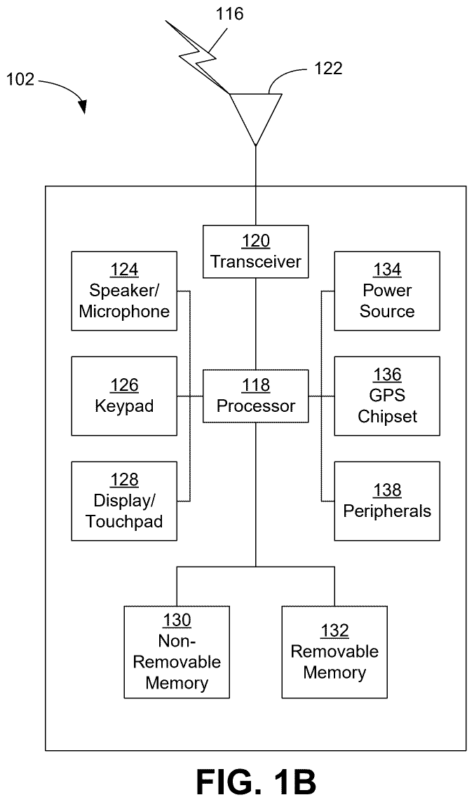

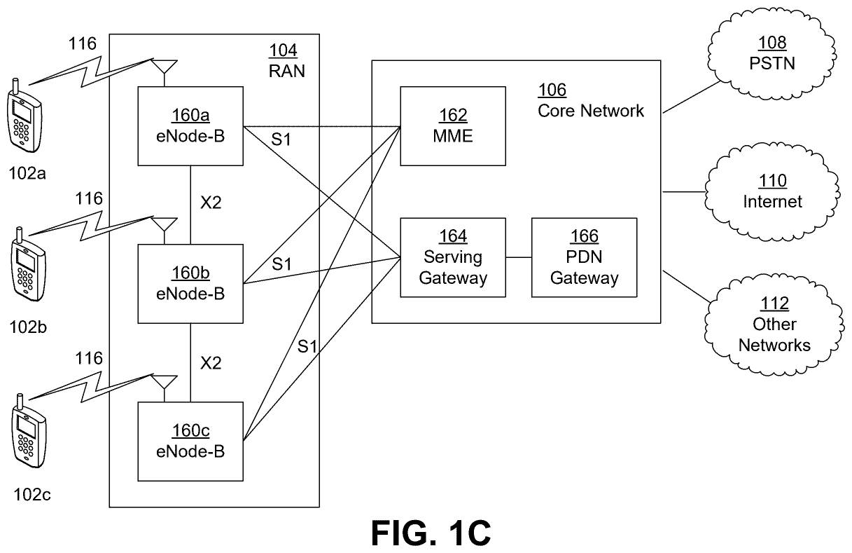

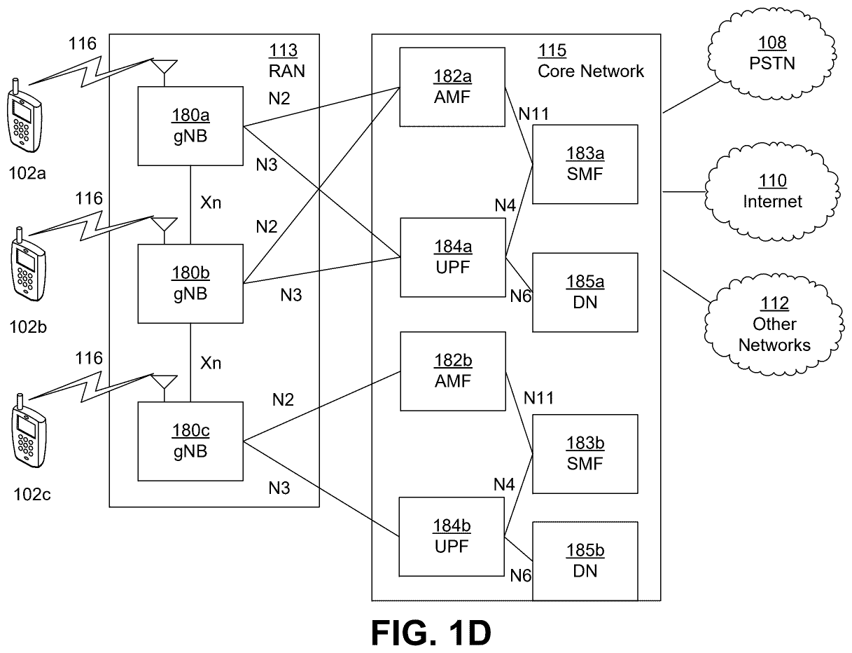

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c.

Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Artificial intelligence (AI)/machine learning (ML) based channel state information (CSI) enhancements may include: AI/ML based CSI compression as a means to reduce CSI feedback reporting overhead. AI/ML based CSI prediction may include mitigating channel aging and/or reducing the CSI feedback overhead.

CSI processing criteria and/or CSI prioritization rules may use predefined rules in (e.g., legacy) CSI reporting for the determination of CSI processing time and/or for scheduling CSI reporting based on the priority of reports. Rules for prioritization may be (e.g., mainly) based on the report periodicity configuration, the serving cell index, the configured content of the report (e.g., whether the report is carrying layer 1 (L1)—reference signal received power (RSRP) and/or L1-signal to noise and interference ratio (SINR). Two CSI reports may collide if the time occupancy of the physical channels scheduled to carry the CSI reports overlap in at least one orthogonal frequency-division multiplexing (OFDM) symbol and/or are transmitted on the same carrier.

CSI processing time and/or CSI prioritization rules may support non-AI/ML (e.g., legacy) schemes for CSI processing. The CSI enhancements system information (SI) may show that AI/ML embodiments have more potential to improve the other (e.g., legacy) scheme and/or may include specific rules to AI/ML models considering different aspects (e.g., rules for scheduling multiple life-cycle management (LCM) functions), and/or AI/ML related aspects (e.g., model size, model complexity in terms of computing resources, computing time, and/or other metrics, additional resources for pre/post-processing, and/or other considerations related to applicable conditions and/or model specifications).

For scenarios where there are collisions between one or more (e.g., multiple) LCM functions for the same active AI/ML model, devising (e.g., explicit) rules for determining the priority order and/or scheduling LCM events based on complexity metrics for efficient resource allocation and/or other aspects may be a problem and/or may include ensuring a continuous life cycle management of one or more (e.g., any) active model while maintaining its desired performance and/or allocating the available resources in an optimal way.

For system using WTRU-side AI/ML models for CSI processing, one or more of the following may be addressed. How to efficiently represent and/or report different aspects of the complexity of active AI/ML models for a use-case (e.g., CSI processing) may be addressed. How to handle collision between one or more (e.g., multiple) LCM functions (e.g., inference and/or performance monitoring) may be addressed. How to allocate processing unit (PU) resources for scheduling one or more (e.g., multiple) LCM functions may be addressed.

A WTRU supporting a set of AI/ML models may handle collision between one or more (e.g., multiple) LCM function reports, for example, by determining the priority order of each LCM functions as a function of one or more of: the active AI/ML model complexity, available resource(s) including the number of unoccupied processing units (PUs) (e.g., central PUs (CPUs)), model performance and/or applicable condition(s). The WTRU may transmit measurement(s) for the LCM function(s), for example, based on the determined priority order and/or available UL resources, and/or may send the LCM collision report.

A WTRU may send a report that indicates AI/ML capability of the WTRU. For example, a WTRU may report the AI/ML capability, which may include the complexity metric for each LCM function, complexity specific to a AI/ML functionality, and/or a maximum total processing units support by the WTRU (e.g., across al LCM functions and/or specific to each LCM function. The complexity metric for each LCM function may include a first complexity metric for inference and/or a second complexity metric for performance monitoring. An LCM function may include one or more of: inference, AI/ML model performance evaluation, and/or AI/ML model validation evaluation. Complexity (e.g., processing units) specific to an AI/ML functionality may include a maximum of one or more (e.g., all) AI/ML models for a given functionality, average of AI/ML models within a functionality, sum of AI/ML models, etc. Complexity (e.g., processing units) specific to an AI/ML functionality may include a complexity specific to an AI/ML model. Complexity (e.g., processing units) specific to an AI/ML functionality may include the WTRU reporting the use case(s) described herein (e.g., max of all AI/ML models for a given functionality, average of AI/ML models within a functionality, sum of AI/ML models, complexity specific to a AI/ML model, etc.). For example, this may be about the complexity specific to a AI/ML functionality, which can be reported per AI/ML use-case (e.g., CSI processing, Beam Management (BM), Positioning, etc.).

A WTRU may receive configuration information. The configuration information may indicate that the WTRU is to perform a plurality of LCM functions. Each LCM function of the plurality of LCM functions may be associated with AI/ML functionality of one or more AI/ML models operated by the WTRU. The configuration information may include configuration for measurement reporting, configuration for AI/ML model monitoring, configuration for LCM function prioritization, and/or configuration for LCM function collision reporting. The WTRU may receive configuration information for measurement reporting (e.g., CSI reporting) supporting one or more LCM function(s), which may include one or more of the following. Configuration information may include one or more configuration(s) for measurement reporting (e.g., including one or more of: UL resources for reporting, reporting format, etc.). Configuration information may include configuration for AI/ML model monitoring (e.g., monitoring type, monitoring mode). Monitoring type may include local encoder/decoder model monitoring, input distribution monitoring, and/or latent distribution monitoring. Monitoring mode may include an active model monitoring and/or parameters thereof, and/or an inactive model monitoring and/or parameters thereof (e.g., a maximum number of inactive models to monitor). Configuration information may include configuration for LCM function prioritization. Configuration for LCM function prioritization may include a value of N (e.g., for determining top N measurement reports). Configuration for LCM function prioritization may include a set of applicable condition(s) and/or their associated threshold(s). Configuration for LCM function prioritization may include LCM function preference configuration and/or per measurement reporting configuration and/or per LCM function. Configuration for LCM function prioritization may include one or more thresholds on performance, and/or a window size for historical performance. Configuration for LCM function prioritization may include (pre) defined weights for measurement type priority and/or LCM function determination associated with one or more (e.g., multiple) rules and/or criteria. The WTRU may determine the priority of each LCM function based on one or more rules. The one or more rules may include a measurement priority, a LCM function priority, and/or a number of processing units (PUs). The WTRU may receive configuration for LCM function collision reporting (e.g., to report dropped LCM function(s)). Configuration for LCM function collision reporting may include UL resources, periodicity, conditions, etc. for LCM collision reporting and/or a set of complexity metrics to report.

A WTRU may be configured to report more than one measurement report (e.g., associated with more than one LCM function) in a first reporting occasion using a first reporting configuration. For example, the WTRU may determine a plurality of measurement reports associated with a first reporting occasion based on the configuration information. Each measurement report of the plurality of measurement reports may be associated with at least one LCM function of the plurality of LCM functions.

A WTRU may determine a priority of each LCM function of the plurality of LCM functions, for example, based on the configuration. A WTRU may determine a priority order for LCM function(s) for which it is configured to transmit a measurement report in the first reporting occasion, for example, based on the configuration and/or one or more of the following: the measurement priority; LCM function priority (e.g., weighted LCM function, weighted model performance, weighted applicable condition(s)); and/or a number of PUs (e.g., maximum number of PUs, or PUs required per measurement and/or LCM function). The measurement priority may be based on one or more of a measurement report type (e.g., periodic, aperiodic, semi-persistent), a measurement report quantity, serving cell index, and/or a report configuration. The LCM function priority may include a weighted LCM function, a weighted model performance, and/or a weighted applicable condition.

A WTRU may select the measurement report(s) to include in a transmission using the first reporting occasion. For example, the WTRU may determine a subset of the plurality of measurement reports to include in a transmission for the first reporting occasion based on the priority of each LCM function of the plurality of LCM functions. Determining the subset of the plurality of measurement reports may include dropping one or more measurements (e.g., when PU resources are not available) and/or measurement reports (e.g., when UL resources are not available) based on the determined priority of each LCM function and/or the configuration information. For example, a WTRU may determine that at least one measurement report is dropped from a transmission using the first reporting occasion based on the determined priority order for LCM function(s) and/or the first reporting configuration. For example, if the capacity of the first reporting resource cannot accommodate one or more (e.g., all) of the measurement reports, the WTRU may drop the measurement report(s) of lowest priority LCM functions until the payload of measurement reports is less than and/or equal to the capacity of the first reporting resource. For example, if the number of PUs required to obtain one or more (e.g., all) the measurement reports configured to be transmitted in the first reporting occasion is greater than the maximum number of PUs, the WTRU may drop the measurement report(s) of the lowest priority LCM functions until the number of PUs of measurement reports is less than and/or equal to the maximum number of PUs.

A WTRU may transmit the selected measurement report(s) using the first measurement occasion. For example, the WTRU may send the subset of measurement reports in the transmission for the first reporting occasion. Sending the subset of measurement reports may include sending one or more channel state information (CSI) measurements. The WTRU may transmit an LCM collision report. For example, the WTRU may transmit the LCM collision report in a second reporting occasion using a second reporting configuration and/or may include one or more dropping causes (e.g., Inference functions with no UL resources, Inference functions with no PU resources, monitoring functions with no PU resources. The LCM collision report may include an indication of one or more dropped LCM functions.

The embodiments described herein may be applicable to one or more (e.g., any) use case and/or may not be limited to CSI. The embodiments described herein may be applicable to one or more LCM function(s) (e.g., data collection, fine-tuning, etc.) and/or may not be limited to inference and/or performance monitoring. For example, the plurality of LCM functions may include any combination of inference, data collection, training, fine-tuning, performance monitoring, model transfer, model selection, model activation/deactivation, and/or model switching.

For AI/ML based measurement that supports LCM functions (e.g., CSI processing), the rules for prioritization may be different, taking into account other considerations (e.g., different metrics reflecting the model complexity), and/or (e.g., explicit, new) rules specific to different LCM functionalities. Other (e.g., new) priority rules specific to LCM function(s) and/or model complexity may be included to ensure optimal scheduling of different LCM functions and/or to prevent collisions between LCM reports, for example, based on inference and/or performance monitoring of active AI/ML models. This may be due to the fact that AI/ML models require different resources based on the model complexity and/or based on which LCM function is initiated. Additionally or alternatively, (e.g., sophisticated) priority rules and/or scheduling may enable stable performance of the model, while ensuring that performance of the model is accurately tracked and/or monitored without impacting performance in different measurement reporting occasions. Embodiments described herein regard enabling rules (e.g., explicit, new) for prioritization of AI/ML-based LCM functions while (e.g., optimally) managing the occupied and/or unoccupied WTRU's computing resources for scheduling and/or mitigating collisions of LCM functions following the determined priority order. Additionally or alternatively, embodiments described herein include scheduling the allocation of UL resources for one or more (e.g., multiple) LCM reports.

Life-cycle management (LCM) function is described herein. LCM may be related to a AI/ML model and/or a AI/ML functionality. For example, one or more LCM functions may include: model activation/deactivation, training/retraining, fine-tuning, model switching, inference, performance monitoring, model selection, and/or the like.

Processing Unit (PU) is described herein. A processing unit may be a complexity unit to represent the computing resources and/or computational complexity required by an algorithm/function/processing performed by the WTRU. For example, processing could be related to one or more AI/ML operations. This metric may represent a soft metro used as an abstraction of the required computational resources to execute a task. For example, the PU used for the CSI processing use-case may refer to CSI processing unit (CPU).

Embodiments described herein may include a procedure for handling complexity for one or more (e.g., multiple) LCM functions. A WTRU may express and/or report the complexity of a AI/ML model using different metrics (e.g., AI/ML complexity metrics). Complexity metrics may be specific to training, scalability, generalization, and/or inference. Complexity metrics may be time-relative and/or relative to a reference size/dimension. A metric used to express complexity may be floating-point operations per second (FLOPs) (e.g., the number of floating-point operations when inferring one input sample, which may measure the computational efficiency). Another metric that may be used to determine a AI/ML model complexity is the storage complexity, which may be defined by the number of parameters included the trained/pre-trained AI/ML model. Other complexity metrics can be considered for evaluating AI/ML models, including one or more of the following metrics.

Storage complexity may be a complexity metric used to evaluate AI/ML models. The storage complexity may reflect the memory required to store the model. Storage complexity can be expressed as a function of the number of trainable parameters of the AI/ML model. In examples, the number of non-trainable parameters may be additionally added to express the storage complexity. Storage complexity may be a function of the AI/ML model architecture, including the depth (e.g., number of hidden layers) and/or width (e.g., number of neurons), types of layers, and/or types of activation functions.

FLOPs may be a complexity metric used to evaluate AI/ML models. FLOPs may capture the density of the connections between different processing units (within layers), implying matrix multiplications, activation functions, and/or gradient calculations. FLOPs may be used to measure the computational complexity and/or efficiency. In examples, the number of floating-point operations can be time-relative expressed, especially for time-sensitive inference of AI/ML models when applied to (e.g., critical) time-dependent systems. In examples, the computational complexity may be expressed in terms of FLOPs. This complexity metric may be useful for the measurement of computing speed and/or hardware performance.

Multiple and Accumulate operations (MACs) may be a complexity metric used to evaluate AI/ML models. In examples, when the AI/ML model architecture is a convolutional neural network (CNN), the complexity may be expressed in terms of MACs, which may include linear algebra operations (e.g., matrix multiplications, convolutions, dot products, etc.).

Sample complexity may be a complexity metric used to evaluate AI/ML models. Sample complexity may be used to express the number of sample data that a AI/ML model requires to achieve a certain level of learning performance. Sample complexity may be relevant, for example, when a WTRU is training, retraining, and/or fine-tuning a AI/ML model.

Scalability may be a complexity metric used to evaluate AI/ML models. When a AI/ML model is pre-trained/trained on a specific dataset (e.g., localized model) and/or on a fixed input size/dimension, the scalability may be used to determine how performance scales with increasing input sizes and/or computational resources. A model may be trained on a specific cell/site/area. For example, a model can be trained on a fixed spatial and/or temporal and/or frequency dimension, then its scalability performance/complexity may be measured by the AI/ML model performance when inferring different (higher or lower) dimensions. In examples, when the computational resources increase, the model performance can be evaluated to identify the trade-off between performance and computational complexity.

Input size may be a complexity metric used to evaluate AI/ML models. The input size of a AI/ML model may be used for the determination of its complexity, and/or may be related to other complexity metrics. The input size may include the inference sample input size, and/or the size of additional/assistance side information used by the AI/ML model. For example, in CSI prediction use-case, the size of the observation window may be relevant and/or may impact one or more (e.g., many) aspects of the complexity. An example may include the TSF case 1 and case 2, in which a two-sided is employed, and/or may require a historical buffer at the encoder for the former, and a historical buffer at the encoder and decoder for the latter.

Space complexity may be a complexity metric used to evaluate AI/ML models. Space complexity may be used to evaluate the amount of extra memory to execute a AI/ML model in inference. This metric may be determined with respect to an input size n.

Time complexity may be a complexity metric used to evaluate AI/ML models. Time complexity metrics may be used for evaluating the inference latency and/or estimating the processing time with respect to a fixed input size n. An input size n may be used as a reference sample size (one input sample), and/or time complexity may be relatively calculated for other input sizes. Time complexity may be used to evaluate how fast/slow a AI/ML model can perform, for training, and/or inference.

The number of processing units (PUs) may be a complexity metric used to evaluate AI/ML models. The number of processing units (PUs) may be used to abstract the complexity required by different AI/ML LCM functions, e.g., inference and/or monitoring. The PU may be a soft metric (e.g., not necessarily related to hardware PUs), and/or may represent a unit for expressing the computational complexity. For example, for evaluating a AI/ML model required PUs for inference, inference only PUs may be considered in addition to PUs required for measurements, for pre-processing, and/or for post-processing. Similarly, for performance monitoring, more PUs may be required for post-processing of the results, (e.g., for calculating intermediate key performance indicators (KPIs)).

A WTRU may be configured by at least one complexity metric (e.g., as described herein) to include in the capability report, per AI/ML model, per LCM function, and/or per use-case. In examples, the WTRU may report one or more complexity metrics for inference, and/or for performance monitoring. In examples, the report may include complexity metrics specific to a AI/ML functionality. For example, for a given functionality and/or one or more complexity metrics, a WTRU may report the maximum value of one or more (e.g., all) supported AI/ML models, and/or the average value of the AI/ML models within a functionality. In examples, the WTRU may report the sum of the complexity required by the supported AI/ML models.

In examples, a WTRU may include in the capability report the complexity specific to a specific AI/ML model (e.g., MAC's corresponding to a CNN model). The WTRU may report the complexity metric(s) per use-case.

A WTRU may add additional information specific to supported AI/ML models, for example, if a model requires side/assistance information, reference input size n, localized and/or generic model, and/or a set of applicable condition(s) associated to a AI/ML model instance. The reported complexity may be the maximum total complexity supported by a WTRU, for example, across one or more (e.g., all) LCM functions, and/or specific to each LCM function.

In examples, a WTRU may include one or more additional details. For example, the WTRU may split the total number of required CPUs for inference into one or more (e.g., three) categories, where the categories may be, for example, inference processing units (IPUs), measurement processing units (MPUs), pre-processing units (PPUs), and/or post-processing units (PPUSₚₒₛₜ). In examples, the granularity of CPUs may facilitate the determination of the total number of PUs required for a specific LCM function (e.g., for performance monitoring). For example, performance monitoring may be defined as an inference process with one or more samples, plus additional post-processing.

In examples, the WTRU may transmit the WTRU capability report upon receiving WTRU capability enquiry from the network. In examples, the WTRU may initiate the WTRU capability report upon a change in WTRU capability. AI/ML capability may change based on the available complexity (e.g., PUs). For example, AI/ML capability may change if one or more other (e.g., new) models become available at the WTRU (e.g., due to model training/retraining/download/fine-tuning). For example, AI/ML capability may change if the capability is shared for different applications radio-level processing (e.g., radio-level processing, for example, CSI and/or BM) and/or application processing (e.g., image and/or video processing). For example, AI/ML capability may change based on the available capacity dynamically changing (e.g., WTRU-based events which may not be visible to the NW, which may include a WTRU over-heating). For example, AI/ML capability may change if one or more LCM functions are configured, and/or when one or more AI/ML models are deactivated (e.g., in a previous occasion). For example, AI/ML capability may change if the associated applicable condition(s) change (e.g., after model switching). In examples, the WTRU may report AI/ML capability/complexity metric along with radio access capability information. In examples, the WTRU may report AI/ML capability/complexity metric in a separate/dedicated AI/ML capability information. The AI/ML capability information may be reported in the same RRC message and/or in a different signal radio bearer (SRB) (e.g., SRBx) than the one that carries radio access capability information. In examples, the WTRU may send the baseline AI/ML capability in a RRC message and/or an update to the baseline AI/ML capability in a medium access control (MAC)-Control entity (CE) and/or a uplink control information (UCI).

Examples may include a WTRU equipped with a finite number of AI/ML models for a specific use-case (e.g., beam management (BM) and/or positioning, CSI prediction, and/or CSI compression). For example, with respect to the use-case CSI prediction, the WTRU may be equipped with one or more one-sided AI/ML models for prediction of future CSI instances based on a historical observation window of a pre-defined size.

A WTRU may be configured with M CSI reporting configurations. Each CSI report may be configured, for example, for (e.g., either, both) inference and/or performance monitoring. For each CSI reporting, and/or for each supported AI/ML model for CSI prediction, a WTRU may determine the complexity in terms of CPUs occupancy/usage (e.g., as per the following). A WTRU may determine the sample input size from the reporting configuration. A WTRU may determine/calculate the number of CSI processing units NPUs required for each phase (e.g., pre/post processing and/or inference), for a pre-configured input size and/or for a reference input size (if not pre-configured), and/or per LCM function (e.g., inference and/or monitoring). PUs for measurements (PMUs) may include the number of PUs required for measurements. For example, PMUs may include channel estimation, applicable condition(s), additional information, side information, and/or input statistical measurements (e.g., in monitoring Type 2). PUs for pre-processing (PrePUs) may include the number of PUs required for pre-processing one sample (e.g., PUs required for beam-domain pre-processing, EV inputs, raw channel matrix inputs). PUs for inference (IPUs) may include the number of PUs required for processing one inference task of a sample (e.g., between the input and output of the AI/ML model). PUs for pos-processing (PostPUs) may include the number of PUs required for post-processing the output of the AI/ML model. For inference, post-processing may include (re) normalization, (re) shaping, updating the historical buffer, etc. For performance monitoring, post-processing may include one or more of the same operation sin inference, and/or PUs for calculating performance. For example, performance may include KPI, relative performance, historical performance, statistical measurements (e.g., in monitoring Type 2), etc. A WTRU may determine the total number of PUs required by each configured LCM function as follows:

$$NPU = MPU + PrePU + IPU + PostPU$$

In examples, if the configured performance monitoring LCM function requires more than one sample, the WTRU may scale NPU based on the number of configured samples. For example, for both inference and monitoring, the exact total number of required PUs may scale with respect to the input size/dimension. If performance monitoring is Type 2 (e.g., based on input/output distribution, then more measurement and/or post-processing PUs may be considered in the calculations, corresponding to the statistical calculations on the inputs and/or outputs of the AI/ML model.

The exact values of the numbers of required PUs may be a function of, but not limited to, the LCM function, the input size, the AI/ML model, and/or the use-case.

A WTRU may receive (e.g., via RRC) configuration for measurement reporting (e.g., CSI). The configuration may include one or more of the following: configuration for the measurement report, configuration for monitoring, configuration for LCM prioritization, and/or configuration for LCM collision reporting.

The configuration for measurement reporting may include the number of configured measurement reporting configurations M, (e.g., the number of report configurations received by the WTRU). The configuration thereof may (e.g., also) include UL resources for reporting, reporting format, and/or reporting periodicity configuration.

For the configuration for monitoring, a WTRU may be configured with one or more (e.g., two) performance monitoring types. In examples, a WTRU may be configured with Type 1, where in Type 1 monitoring, the WTRU may monitor the KPI of the active and/or inactive AI/ML model (e.g., for CSI prediction or compression use-cases). In examples, a WTRU may consider the PU occupancy required by its one-sided AI/ML model for CSI prediction; and/or in another use-case, the WTRU may consider the PUs required for the encoder and/or the local decoder (proxy decoder) when the use-case is CSI compression. In examples, the WTRU may (e.g., only) consider the complexity of the encoder (e.g., in case the local decoder is not used in intermediate inferences within a performance monitoring window). In examples, a WTRU may be configured with Type 2 monitoring, where the WTRU may monitor the performance of its AI/ML model using statistical input distribution, and/or latent distribution (e.g., in the CSI compression use-case). In examples, the WTRU may (e.g., also) calculate the alignment of the input sample with the AI/ML model's applicable conditions and/or additional information, where the WTRU may collect measurements based on the applicable conditions included in the model specs. In examples, a WTRU may be configured to use Type 1 monitoring as a default option, where the WTRU may receive in the configuration an indication/flag to switch to performance monitoring type 2.

A WTRU may be configured with performance monitoring modes, where, for example, performance monitoring with Mode 1 can be configured for monitoring active AI/ML models, whereas performance monitoring with Mode 2 can be for monitoring inactive AI/ML models. Similarly to monitoring types, a WTRU may be pre-configured by a default mode (e.g., Mode 1 or Mode 2). For example, Mode 1 may be the default mode if the active AI/ML model is a localized model, or Mode 2 can be the default mode in case a (e.g., generic) AI/ML model is active. In examples, Mode 1 and/or Mode 2 can be further configured with a model switching configuration, whereas Mode 2 can (e.g., only) be configured with a model selection configuration.

For Mode 2, a WTRU may be (e.g., explicitly) configured with the number of inactive models to monitor in an option. In examples, a WTRU may be configured with a maximum number of allowed inactive AI/ML models. In examples, the WTRU may determine the number of inactive models to monitor, which can be configured based on the available PUs and/or based on other complexity metrics related to inactive models. The UE may include the number of inactive models monitored in the capability report.

A WTRU may receive configuration for LCM prioritization, wherein the configuration thereof may include one or more of the following: value of N; thresholds associated to a set of applicable conditions; LCM preference configuration; weights for CSI prioritization rules; and/or LCM collision reporting configuration. In examples, a WTRU may be configured with and/or receive dynamically (e.g., via MAC CE and/or DCI) a flag indicating the necessity to report dropped reports, for example, due to lack of PUs and/or due to a lack of UL resources.

Value of N may be used by the WTRU to select the top N highest priority measurement reports. N may refer to the number of top priority reports to determine among M configured reports. In examples, N may be configured dynamically (e.g., via MAC CE and/or DCI) in function of the available CPU resources and/or UL resources at the WTRU side. In examples, N may be dynamically configured/tuned by the WTRU in function of its available computational resources and/or UL resources.

The configuration information may include thresholds associated to a set of applicable conditions. For a given AI/ML model per use-case, a WTRU may receive a configuration that includes thresholds associated to a set of applicable conditions, where applicable conditions may be based on the AI/ML model specification(s) (e.g., how the model was trained and/or which applicable condition(s) are used as a side information, and/or which applicable conditions are specific to the training dataset used for a AI/ML model). In examples, a WTRU may use the thresholds for the verification of the alignment of the input sample applicable conditions, with the applicable conditions values considered in training the AI/ML model. For example, this configuration may assist the WTRU to determine the priority order/score of a measurement report. Additionally or alternatively, this configuration may assist the WTRU to initiate model switching if the conditions herein and/or additional conditions are not met. Examples of such applicable conditions may include WTRU speed, coherence time, time-domain channel property (TDCP), delay spread, rank order, Traffic, etc.

The configuration information may include LCM preference configuration. A WTRU may receive an indication/flag from the network (NW) to prioritize an LCM function over another one, (e.g., monitoring over inference or vice-versa). In examples, the LCM preference flag may assist the WTRU to prioritize one or more (e.g., some) measurement reports based on the configured LCM function, given a limited computational complexity. In examples, the LCM preference configuration may assist the WTRU to schedule the transmission of the measurement report given a limited number of UL resources. The LCM preference configuration may be configured for one or more (e.g., all) of the reporting configurations, and/or for a subset thereof, and/or =per single reporting configuration.

The configuration information may include weights for (e.g., CSI) prioritization rules. A WTRU may receive a set of weights associated one or more (e.g., multiple) rules/criteria considered in the determination of the measurement report priority order. The weights may assist the WTRU to (e.g., relatively) give more/less importance to one or more (e.g., some) configured rules. As an example, a WTRU may be configured by a higher weight for applicable conditions alignment compared to performance and/or complexity. This may be in case, for example, a AI/ML model is localized to a cell/site/area, but the model was activated and/or applied in a different environment, implying some performance degradation. In this case, if the model is active in its cell/site/area, matching the applicable conditions may be more important than historical performance, as the model may perform stronger (e.g., well) when the measured applicable conditions match the ones in the model specification. In examples, a WTRU may be configured to use AI/ML specific rules on top of the other (e.g., legacy) rules (e.g., for CSI processing). In examples, a WTRU may be configured to use restricted rules, specific to AI/ML (e.g., AI/ML only).

The configuration information may include LCM collision reporting configuration. A WTRU may receive a configuration for LCM collision reporting. The configuration may include UL resources, periodicity of the LCM collision report (e.g., periodic, aperiodic, semi-persistent, NW triggered, WTRU triggered). In examples, if the periodicity is configured to be WTRU-triggered, the WTRU may receive additional configuration including one or more conditions for transmitting the LCM collision report. In examples, a WTRU may be configured with and/or receive dynamically (e.g., via MAC CE and/or DCI) a flag indicating the necessity to report dropped reports, for example, due to lack of PUs and/or due to a lack of UL resources. A WTRU may add additional information on the cause of the dropping, per measurement report, and/or per LCM function (e.g., in case the LCM preference flag was configured and the WTRU dropped all reports associated to a specific LCM function). In examples, a WTRU may be additionally configured with a set of complexity metrics to include in the LCM collision report.

A WTRU may be configured to determine the priority order for one or more (e.g., multiple) LCM functions. Although one or more methods herein are described in terms of CSI reporting, the one or more methods may be applicable to any measurement reporting and/or feedback. For example, CSI processing unit (CPU) may be used interchangeably with Processing Unit (PU) and/or may be applicable for any measurement processing at the WTRU. For example, CSI-RS may be used interchangeably with any RS. For example, CSI reporting resource may be any UL reporting resource physical uplink control channel (PUCCH), physical uplink shared channel (PUSCH), random access channel (RACH), sounding reference signal (SRS), etc., including uplink control information (UCI), MAC-CE, radio resource control (RRC) message(s), and/or the like.

A WTRU may be configured to measure and/or report one or more (e.g., multiple) CSI, where each CSI may be associated with one or more of: CSI-RS resource (e.g., one or more of channel measurement resource, interference measurement resources, zero-power CSI-RS resource, non-zero power CSI-RS resource etc.); CSI-RS resource type (e.g., periodic, aperiodic, semi-persistent etc.); CSI report type (e.g., periodic or aperiodic or semi-persistent etc.); CSI reporting resource (e.g., PUCCH, PUSCH, etc.); CSI report quantity (e.g., channel quality indicator (CQI), precoding matrix indicator (PMI), rank indicator (RI), type of codebook, reference signal received power (RSRP), reference signal strength indicator (RSSI), SINR, reference signal received quality (RSRQ), CSI resource indicator (CRI), etc.); Serving cell index (e.g., the cell for which the CSI is reported), report configuration, etc.

In examples, the WTRU may be configured to perform a set of LCM functions. For example, the set of LCM functions may be configured for a logical unit of AI/ML operation. For example, the LCM functions in the set may include one or more of inference, data collection, training, fine-tuning, performance monitoring, model transfer, model selection, model activation/deactivation, model switching, etc. In examples, the set of LCM functions may be associated with and/or configured for a AI/ML functionality. Each AI/ML functionality may be associated with one or more AI/ML models. In examples, the set of LCM functions may be associated with and/or configured for a AI/ML model. In examples, the set of LCM functions may be associated with and/or configured for a CSI-RS resource and/or CSI measurement and/or CSI report. In examples, the set of LCM functions may be associated with and/or configured for a combination of AI/ML functionality and a configuration of inputs to the AI/ML functionality. In examples, the set of LCM functions may be associated with and/or configured for a combination of AI/ML functionality and a configuration of output from the AIML functionality.

A WTRU may be capable of performing at most C AI/ML operations at a given time interval. Herein, the value of C may be a function of the architecture of AI/ML model, a number of parameters in the AIML model, a number of floating point operations associated with AI/ML model, a number of floating points, a type of hardware acceleration (e.g., Graphic Processing Units, Neural Processing Units, Tensor Processing Units, and/or the like), a clock speed, a number of cores, a memory bandwidth, a floating point precision, a thermal management, etc.

In examples, each CSI may be associated with a set of LCM functions. Different CSI may be associated with different set of LCM functions. The WTRU may be configured to derive priority of a CSI based on one or more of: a CSI report type, a report quantity, CSI-RS resource characteristics, a serving cell index, and/or a reporting configuration. In examples, the WTRU may prioritize the CSI report that leads to increased throughput and/or decreased block error rate (BLER). In examples, the WTRU may be configured to prioritize LCM functions based on the priority of the CSI to which the LCM function is associated with. For example, the WTRU may be configured to prioritize LCM functions associated with highest priority CSI.

In examples, each CSI may be associated with a set of LCM functions. Different CSI may be associated with different set(s) of LCM functions. A WTRU may be configured to derive priority of a LCM function based on one or more of: a type of LCM function, a complexity of LCM function, a performance of AI model, an applicability of the AI model, and/or the like. In examples, the WTRU may be preconfigured with priority order for the LCM functions. For example, the preconfigured priority order may be as follows: inference is highest priority, followed by performance monitoring mode:1, performance monitoring mode:2, data collection, fine tuning, training, model transfer, etc. For example, the WTRU may be configured to prioritize the highest priority LCM function and the CSI associated with that LCM function. In examples, each CSI may be associated with a set of LCM functions. The WTRU may derive priority of a CSI based on preconfigured rules. The WTRU may derive priority of a LCM function based on preconfigured rules. In examples, a WTRU may be configured to determine a top N high priority CSIs and/or perform top M_{L} high priority LCM functions associated with that CSIs. In examples, the WTRU may be configured to determine a top M_{L} high priority LCM functions and process the top N high priority CSIs. In examples, the value of N and M_{L} may be configured for a WTRU by the NW. In examples, the value of N and M_{L} may be a function of WTRU capability. In examples, the WTRU may be configured to select N and M_{L} subject to its capability based on preconfigured rules. In examples, the rule may be based on maximizing the number of CSI reports that can be transmitted on the UL resources configured and/or available for the WTRU. In examples, the rule may be based on maximizing the quality and/or performance of CSI reports transmitted. In examples, the rule may be based on minimizing the latency of CSI processing.

The WTRU may be configured to transmit up to a maximum of M CSI reports. Given a maximum WTRU capability C and allocated UL resources U, the WTRU may transmit T CSI reports. In examples, the WTRU may determine T as a maximum value that satisfies the following conditions: T<=M and size of T CSI reports<=the max payload size of uplink resources U and processing required for T<=WTRU capability C.

A WTRU may determine a priority order associated with a subset of the plurality of measurement reports. Determining the priority of each LCM function may be based on the determined priority order associated with the subset of the plurality of measurement reports. In examples, the WTRU may be configured with one or more of the following: a first LCM function, a second LCM function, a third LCM function and a fourth LCM function. The WTRU may be configured with a first set of CSI reports (e.g., N CSI reports out of M CSI reports) to be in a high priority group and a second set of CSI reports (e.g., M-N CSI reports out of M CSI reports) to be in a low priority group. For example, this may be extended (e.g., more generally) to K sets. Within the first set of CSI reports, each individual CSI report may be assigned as priority. The second set of CSI reports each individual CSI report may be assigned a priority. In examples, the WTRU may apply the following prioritization algorithm. The WTRU may allocate PUs (e.g., CPUs) for a first LCM function for top N CSI reports in the order of priority. If there are more PUs (e.g., CPUs) are left, the WTRU may allocate PUs (e.g., CPUs) for a second LCM function (if configured) for N in the order of CSI priority. If more PUs (e.g., CPUs) are left, the WTRU may allocate PUs (e.g., CPUs) for a third LCM function (if configured) for remaining M-N CSI reports in the order of CSI priority. If more PUs (e.g., CPUs) are left, the WTRU may allocate PUs (e.g., CPUs) for a fourth LCM function (if configured) for remaining M-N CSI reports in the order of CSI priority.

In a first option, the WTRU may be configured with the first LCM function as inference and performance monitoring with mode:1. Second LCM function may be NULL configuration/not configured. Third LCM function may be inference and fourth LCM function may be performance monitoring with mode:1.

In a second option, the WTRU may be configured with inference as the first LCM function and performance monitoring with mode:1 as the second LCM function, inference as third LCM function and performance monitoring with mode:1 as fourth LCM function.

In a third option, the WTRU may be configured with inference and performance monitoring with mode:1 as first LCM function. As a second LCM function the WTRU may be configured to do performance monitoring with mode:2 if the model performance is below a threshold and/or if the applicability condition is NOT satisfied. Inference and performance monitoring with mode:1 as third LCM function. As a fourth LCM function the WTRU may be configured to do performance monitoring with mode:2 if the model performance is below a threshold and/or if the applicability condition is NOT satisfied.

In a fourth option, the WTRU may be configured with the first LCM function as inference if the AI/ML model is activated; otherwise (e.g., if the AI/ML model is inactive), the first LCM function may be performance monitoring in mode:2. Second LCM function may be configured as performance monitoring in mode:2 if the model is active and the model performance is below a threshold and/or the applicability condition is NOT satisfied. The WTRU may be configured with the third LCM function as inference if the AI/ML model is activated; otherwise (e.g., f the AI/ML model is inactive), the first LCM function may be performance monitoring in mode:2. Fourth LCM function may be configured as performance monitoring in mode:2 if the model is active and the model performance is below a threshold and/or the applicability condition is NOT satisfied.

In one or more examples described herein, a WTRU may be configured with periodicity for the LCM functions. For example, the periodicity may be in terms of time (e.g., milliseconds, slots, and/or the like). For example, the periodicity may be in terms of CSI reports (e.g., every nth CSI report) and/or CSI-RS periodicity (e.g., every nth CSI-RS transmission).

A WTRU may be configured with pre-defined AI/ML specific rules, along with their associated pre-determined weights. In examples, the WTRU may use a separate formula for the determination of the priority order of configured multiple measurement reports supporting LCM functions, where, for example, the formula may include (e.g., only) AI/ML specific terms. In examples, a WTRU may use AI/ML specific rules (and/or their weights) on top of other (e.g., legacy) priority rules (e.g., for CSI report prioritization, WTRU may use new AI/ML specific rules on top of the legacy rules), resulting in a single formula that include more terms. In examples, a WTRU may use pre-determined weights for other (e.g., legacy) rules, where the default weights may be set to 1 and/or can be tuned if the WTRU is configured.

In examples, a WTRU may determine the weights associated to AI/ML specific rules if not configured. In examples, the WTRU may overwrite the configured weights with new updated determined weights (e.g., if WTRU performed performance monitoring of an active AI/ML model but the latest report was not sent to NW, for example, because of lack of UL resources). In examples, the WTRU may determine (e.g., new) updated weights and/or may overwrite the configuration if an inactive AI/ML model was monitored and/or resulted in a other (e.g., new) configuration and/or decision.

In examples, a WTRU may receive a static configuration (rules and/or weights thereof) specific to each configured measurement report (e.g., via RRC signaling). A WTRU may dynamically receive updated weights associated with each measurement report and/or to a specific configured report (e.g., via MAC CE).

For example, for CSI processing (e.g., CSI prediction or compression use-cases) using the legacy (non-AI/ML) scheme, the standardized priority order formula may include terms related to periodicity of the CSI report, serving cell index, CSI report configuration ID, and/or CSI report content. If AI/ML-based CSI processing is active, for example, the WTRU may use additional AI/ML-specific rules on top of the other (e.g., legacy) rules, where each AI/ML-specific rule may be configured with an activation flag (e.g., binary flag) (e.g., if the flag is 0 then the rule is omitted, whereas if the flag is 1 the WTRU may activate the rule). In examples, the activation flag may be represented by the configured weights associated to each rule (e.g., if the weight is 0, the WTRU may omit the rule in the prioritization order formula).

In examples, for AI/ML specific rules, a WTRU may be configured with a weighted LCM function (e.g., each different LCM function has a different importance weight), a weighted model performance indicator, for example a term associated to long-term and/or short-term AI/ML model historical performance. In examples, the model performance rule may be based on the monitoring type (e.g., Type 1 or Type 2 monitoring). Additionally or alternatively, a WTRU may be configured with a term for weighted applicable conditions (e.g., alignment/matching score between the model specs applicable conditions ranges/values and the measured applicable conditions by the WTRU before applying the AIML model to one or more input sample).

The CSI prioritization order determination formula applied by a WTRU for a CSI report indexed by i, that used non-AI/ML legacy scheme may take the following form:

$${Pri}_{legacy , iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

where the terms in the formula are determined as follows:

TABLE 1
Formula terms and definitions

| Term | Determination |
|---|---|
| y = 0 | for PUSCH aperiodic CSI |
| | reports |
| y = 1 | for semi-persistent PUSCH |
| | CSI reports |
| y = 2 | for semi-persistent PUCCH |
| | CSI reports |
| y = 3 | for periodic PUCCH CSI |
| | reports |
| k = 0 | for CSI reports carrying L1- |
| | RSRP and/or L1-SINR |
| k = 1 | for CSI reports not carrying |
| | L1-RSRP and/or L1-SINR |
| c | The serving cell index |
| N_{cells} | The value of the higher layer |
| | parameter |
| | maxNrofServingCells |
| s | reportConfigID |
| Mₛ | The value of the higher layer |
| | parameter maxNrofCSI- |
| | ReportConfiguration |

For this example, a first CSI report may have priority over a second CSI report if the associated Pri_{legacy,iCSI}(y, k, c, s) value is lower for the first report than for the second report.

An example of LCM CSI priority order function that uses AIML specific rules (with configured weights thereof) on top of other (e.g., legacy) rules may take the following form:

$${Pri}_{AIML , iCSI} = {Pri}_{legacy , iCSI} ( y , k , c , s ) + {w}_{1} \cdot {f}_{AIML} ( LCM ) + {w}_{2} \cdot {f}_{AIML} ( AC ) + {w}_{3} \cdot {f}_{AIML} ( P ) + {w}_{4} \cdot {f}_{AIML} ( C )$$

where:

TABLE 2
Formula terms and function definitions

| Term | Function |
|---|---|
| f_{AIML}(LCM) | A function of LCM priority, and w₁ is a |
| | configured importance weight thereof |
| f_{AIML}(AC) | A function of applicable conditions alignment, |
| | and w₂ is a configured importance weight |
| | thereof |
| f_{AIML}(P) | A function of Al/ML model performance, and |
| | w₃ is a configured importance weight thereof |
| f_{AIML}(C) | A function of complexity resources |
| | requirements, and w₄ is a configured |
| | importance weight thereof |

More conditions and/or weights can be added to the AI/ML specific prioritization formula. In examples, an additional weight can be applied to legacy sub-formula, (e.g., w_{legacy}·Pri_{legacy,iCSI}(y, k, c, s)) to control the importance of other (e.g., legacy) rules with respect to other (e.g., new) AI/ML-specific rules.

In examples, a WTRU may normalize the configured weights (between 0 and 1), for example, if the received weights are not normalized and/or if normalization is required. In examples, the WTRU may apply a non-linear function on top of the formula (e.g., sigmoid function of Tanh function) to calculate final prioritization score for the report indexed by i. In examples, one or more terms (e.g., f_{AIML}(AC)) can be a binary indicator, for example, if applicable conditions alignment requirements are met/valid, then f_{AIML}(AC)=1, otherwise f_{AIML}(AC)=0.

In examples, a WTRU may determine the CSI report prioritization order based on the determined/calculated score value. In an option similar to legacy, a report i may have more priority than a report j if its determined score is lower than that of the j^{th} report.

A WTRU may select the measurement reports to include in a transmission using the first reporting occasion and/or may determine that at least one measurement report is dropped from a transmission using the first reporting occasion based on the determined priority order for LCM functions and/or the first reporting configuration. For example, if the capacity of the first reporting resource cannot accommodate one or more (e.g. all) of the measurement reports, the WTRU may drop the measurement report(s) of lowest priority LCM functions until the payload of measurement reports is less than or equal to the capacity of the first reporting resource.

For example, if the number of PUs required to obtain one or more (e.g., all) the measurement reports configured to be transmitted in the first reporting occasion is greater than the maximum number of PUs, the WTRU may drop the measurement reports of the lowest priority LCM functions until the number of PUs of measurement reports is less than or equal to the maximum number of PUs.

In examples, a WTRU may be configured to allocate resources for scheduling measurement reporting (e.g., CSI) supporting LCM function(s) based on one or more conditions. The measurement reports may be AI/ML-driven where the report content may be based on the output of AIML model (e.g., AIML encoder model). A subset of the reports may be legacy-driven. The conditions for scheduling measurement reports may be configured. In examples, the condition may be associated with the priority order of the measurement reports. In a solution, the condition may be associated with the quality and/or performance of the inference results. For example, the condition may be associated with a weightage of the priority order of measurement report and the quality and/or performance of the inference results. For example, x % may be allocated to the priority of the report and/or (1-x) % may be allocated to the performance results, where x∈[0,100] may be configured. For example, given two measurement reports associated with two active models, where report 1 is of higher priority order than report 2 but the inference result associated with report 2 is better than that of report 1, the WTRU may allocate the UL resources based on the configured weightage for priority order and/or performance. In examples, to reflect the importance of the performance in the scheduling decision, different performance regions may be defined, and/or each performance region maybe assigned a score.

A WTRU may allocate the UL resources based on the order of highest priority for a measurement report i, where, i=0, . . . , M. The WTRU may allocate the highest report i if sufficient UL resources are available. In examples, the WTRU may allocate the measurement report i if sufficient UL resource are available and the inference results are available. In examples, the WTRU may allocate the measurement report i if sufficient UL resources are available, inference results are available and the associated performance is above a configured threshold. One or more (e.g., any) of the aforementioned allocation conditions for the active model (e.g., highest priority-based, and/or performance-based and/or combination thereof), may be configured by the NW.

In examples, if there exists remaining UL resources and at least one measurement report is remaining, the WTRU may allocate the remaining resources to at least one of the inactive models as long as its performance is above a configured threshold. The WTRU may indicate the identity and/or the performance of the inactive model. In case there are one or more (e.g., multiple) inactive models, the remaining resources may be allocated based on the priority order of inactive models, and/or based on the ordered performance (e.g., the identity of the inactive model with the highest performance is indicated first). One or more (e.g., multiple) inactive models identities may be reported as long as UL resources are available.

A WTRU performing LCM functions for one or more of its AI/ML models (e.g., active and/or inactive AI/ML models) may feed back a LCM status report, which may include a LCM collision report and/or a WTRU PU (e.g., CPU) occupancy status report.

The LCM collision report may include at least one of the following.

The LCM collision report may include a LCM functionality completion indicator. The LCM functionality completion indicator may indicate whether the configured LCM functions completed successfully or not, and/or it may be configured as a flag (e.g., binary). For example, the WTRU may set the LCM functionality completion indicator 1 when no LCM collisions occur, otherwise it may be set to 0 to signal that LCM collisions occurred.

The LCM collision report may include an indication of dropped LCM function(s). When LCM collisions occurred, the WTRU may report information to identify which LCM functions were dropped and/or information to identify the AI/ML model corresponding to the dropped LCM function. The WTRU may include the WTRU functionality corresponding to the dropped LCM function (where the UE functionality may be AI/ML CSI compression, AI/ML CSI prediction, AI/ML beam management, and/or AI/ML positioning). Additionally or alternatively, the WTRU may include the reason for dropping the LCM function. For example, the WTRU may report: dropped inference functions for the active model due to insufficient PU (e.g., CPU) resources; dropped inference functions for the active model due to no and/or insufficient UL resources to report the inference result; dropped monitoring function for the active model due to insufficient available PU (e.g., CPU) resources; and/or dropped monitoring function for the inactive model due to insufficient available PU (e.g., CPU) resources.

The PU occupancy status report may include at least one of the following.

The PU occupancy status report may include a number of occupied PUs during the LCM window (e.g., most recent configured LCM window), where the LCM window may be configured for monitoring functions, inference functions or both inference and monitoring. The WTRU may report the minimum, maximum, and/or the average number of occupied PUs during the LCM window, for example when the window is comprised of multiple slots or TTIs

The PU occupancy status report may include a number of unoccupied PUs during the LCM window, and/or the minimum/maximum/average number of unoccupied PUs when the LCM window is comprised of multiple slots or TTIs.

The PU occupancy status report may include an estimated number (e.g., minimum, maximum and/or average) of available PUs over a future LCM window (e.g., of pre-defined and/or configured length), where the WTRU may estimate the number of available PUs using specified or configured conditions. For example, the WTRU may estimate the minimum number of available PUs for the next N slots, if the WTRU (e.g., only) performs inference operations for the active ML model (e.g., the ML model for a selected functionality).

In examples, the WTRU may transmit the LCM collision report and/or the PU occupancy status report, for example, when an LCM collision occurred. In examples, the WTRU may report during a second configured reporting occasion using a second reporting configuration, for example, over the data channel (e.g., PUSCH).

In examples, the WTRU may transmit the LCM collision report and/or the PU occupancy status report periodically, using the configured reporting format, the configured reporting periodicity, and/or the configured resources for LCM collision/PU occupancy status reporting.

In examples, the WTRU may be triggered to transmit the LCM collision/PU occupancy status report, for example when one or more (e.g., any) of the following events occur: i) The number of inference functions without available PUs resources exceeds a first configured threshold; ii) The number of inference function outputs without available UL reporting resources exceeds a second configured threshold; and/or iii) The number of monitoring functions without available PUs resources exceeds a third configured threshold.

When the WTRU is triggered to report LCM collision/PU occupancy status, the WTRU may (e.g., first) send a request for UL resources, and/or may transmit the LCM collision/PU occupancy status report upon receiving an UL grant.

A WTRU may send a report that indicates AI/ML capability of the WTRU. For example, a WTRU may report the AI/ML capability, which may include the complexity metric for each LCM function, complexity specific to a AI/ML functionality, and/or a maximum total processing units support by the WTRU (e.g., across al LCM functions and/or specific to each LCM function. The complexity metric for each LCM function may include a first complexity metric for inference and/or a second complexity metric for performance monitoring. An LCM function may include one or more of: inference, AI/ML model performance evaluation, and/or AI/ML model validation evaluation. Complexity (e.g., processing units) specific to an AI/ML functionality may include a maximum of one or more (e.g., all) AI/ML models for a given functionality, average of AI/ML models within a functionality, sum of AI/ML models, etc. Complexity (e.g., processing units) specific to an AI/ML functionality may include a complexity specific to an AI/ML model. Complexity (e.g., processing units) specific to an AI/ML functionality may include the WTRU reporting the use case(s) described herein (e.g., max of all AI/ML models for a given functionality, average of AI/ML models within a functionality, sum of AI/ML models, complexity specific to a AI/ML model, etc.). For example, this may be about the complexity specific to a AI/ML functionality, which can be reported per AI/ML use-case (e.g., CSI processing, Beam Management (BM), Positioning, etc.).

A WTRU may receive configuration information. The configuration information may indicate that the WTRU is to perform a plurality of LCM functions. Each LCM function of the plurality of LCM functions may be associated with AI/ML functionality of one or more AI/ML models operated by the WTRU. The configuration information may include configuration for measurement reporting, configuration for AI/ML model monitoring, configuration for LCM function prioritization, and/or configuration for LCM function collision reporting. The WTRU may receive configuration information for measurement reporting (e.g., CSI reporting) supporting one or more LCM function(s), which may include one or more of the following. Configuration information may include one or more configuration(s) for measurement reporting (e.g., including one or more of: UL resources for reporting, reporting format, etc.). Configuration information may include configuration for AI/ML model monitoring (e.g., monitoring type, monitoring mode). Monitoring type may include local encoder/decoder model monitoring, input distribution monitoring, and/or latent distribution monitoring. Monitoring mode may include an active model monitoring and/or parameters thereof, and/or an inactive model monitoring and/or parameters thereof (e.g., a maximum number of inactive models to monitor). Configuration information may include configuration for LCM function prioritization. Configuration for LCM function prioritization may include a value of N (e.g., for determining top N measurement reports). Configuration for LCM function prioritization may include a set of applicable condition(s) and/or their associated threshold(s). Configuration for LCM function prioritization may include LCM function preference configuration and/or per measurement reporting configuration and/or per LCM function. Configuration for LCM function prioritization may include one or more thresholds on performance, and/or a window size for historical performance. Configuration for LCM function prioritization may include (pre) defined weights for measurement type priority and/or LCM function determination associated with one or more (e.g., multiple) rules and/or criteria. The WTRU may determine the priority of each LCM function based on one or more rules. The one or more rules may include a measurement priority, a LCM function priority, and/or a number of processing units (PUs). The WTRU may receive configuration for LCM function collision reporting (e.g., to report dropped LCM function(s)). Configuration for LCM function collision reporting may include UL resources, periodicity, conditions, etc. for LCM collision reporting and/or a set of complexity metrics to report.

A WTRU may be configured to report more than one measurement report (e.g., associated with more than one LCM function) in a first reporting occasion using a first reporting configuration. For example, the WTRU may determine a plurality of measurement reports associated with a first reporting occasion based on the configuration information. Each measurement report of the plurality of measurement reports may be associated with at least one LCM function of the plurality of LCM functions.

A WTRU may determine a priority of each LCM function of the plurality of LCM functions, for example, based on the configuration. A WTRU may determine a priority order for LCM function(s) for which it is configured to transmit a measurement report in the first reporting occasion, for example, based on the configuration and/or one or more of the following: the measurement priority; LCM function priority (e.g., weighted LCM function, weighted model performance, weighted applicable condition(s)); and/or a number of PUs (e.g., maximum number of PUs, or PUs required per measurement and/or LCM function). The measurement priority may be based on one or more of a measurement report type (e.g., periodic, aperiodic, semi-persistent), a measurement report quantity, serving cell index, and/or a report configuration. The LCM function priority may include a weighted LCM function, a weighted model performance, and/or a weighted applicable condition.

A WTRU may select the measurement report(s) to include in a transmission using the first reporting occasion. For example, the WTRU may determine a subset of the plurality of measurement reports to include in a transmission for the first reporting occasion based on the priority of each LCM function of the plurality of LCM functions. Determining the subset of the plurality of measurement reports may include dropping one or more measurements (e.g., when PU resources are not available) and/or measurement reports (e.g., when UL resources are not available) based on the determined priority of each LCM function and/or the configuration information. For example, a WTRU may determine that at least one measurement report is dropped from a transmission using the first reporting occasion based on the determined priority order for LCM function(s) and/or the first reporting configuration. For example, if the capacity of the first reporting resource cannot accommodate one or more (e.g., all) of the measurement reports, the WTRU may drop the measurement report(s) of lowest priority LCM functions until the payload of measurement reports is less than and/or equal to the capacity of the first reporting resource. For example, if the number of PUs required to obtain one or more (e.g., all) the measurement reports configured to be transmitted in the first reporting occasion is greater than the maximum number of PUs, the WTRU may drop the measurement report(s) of the lowest priority LCM functions until the number of PUs of measurement reports is less than and/or equal to the maximum number of PUs.

A WTRU may transmit the selected measurement report(s) using the first measurement occasion. For example, the WTRU may send the subset of measurement reports in the transmission for the first reporting occasion. Sending the subset of measurement reports may include sending one or more channel state information (CSI) measurements. The WTRU may transmit an LCM collision report. For example, the WTRU may transmit the LCM collision report in a second reporting occasion using a second reporting configuration and/or may include one or more dropping causes (e.g., Inference functions with no UL resources, Inference functions with no PU resources, monitoring functions with no PU resources. The LCM collision report may include an indication of one or more dropped LCM functions.

The embodiments described herein may be applicable to one or more (e.g., any) use case and/or may not be limited to CSI. The embodiments described herein may be applicable to one or more LCM function(s) (e.g., data collection, fine-tuning, etc.) and/or may not be limited to inference and/or performance monitoring. For example, the plurality of LCM functions may include any combination of inference, data collection, training, fine-tuning, performance monitoring, model transfer, model selection, model activation/deactivation, and/or model switching.

1. A wireless transmit/receive unit (WTRU) comprising:
a processor configured to:
receive configuration information, wherein the configuration information indicates that the WTRU is to perform a plurality of life-cycle management (LCM) functions, wherein each LCM function of the plurality of LCM functions is associated with AI/ML functionality of one or more AI/ML models operated by the WTRU;
determine a plurality of measurement reports associated with a first reporting occasion based on the configuration information, wherein each measurement report of the plurality of measurement reports is associated with at least one LCM function of the plurality of LCM functions;
determine a priority of each LCM function of the plurality of LCM functions based on the configuration information;
determine a subset of the plurality of measurement reports to include in a transmission for the first reporting occasion based on the priority of each LCM function of the plurality of LCM functions; and
send the subset of measurement reports in the transmission for the first reporting occasion.

2. The WTRU of claim 1, wherein the plurality of LCM functions comprises any combination of inference, data collection, training, fine-tuning, performance monitoring, model transfer, model selection, model activation/deactivation, and model switching.

3. The WTRU of claim 1, wherein the processor is configured to determine the priority of each LCM function based on one or more rules, wherein the one or more rules comprises a measurement priority, a LCM function priority, or a number of processing units (PUs).

4. The WTRU of claim 3, wherein the measurement priority is based on one or more of a measurement report type, a measurement report quantity, a serving cell index, or a report configuration, and wherein the LCM function priority comprises a weighted LCM function, a weighted model performance, or a weighted applicable condition.

5. The WTRU of claim 1, wherein the processor being configured to determine the subset of the plurality of measurement reports measurements comprises the processor being configured to drop one or more measurements based on the determined priority of each LCM function and the configuration information.

6. The WTRU of claim 1, wherein the processor is further configured to send a report that indicates artificial intelligence/machine learning capability of the WTRU.

7. The WTRU of claim 1, wherein the processor is further configured to transmit a LCM collision report, wherein the LCM collision report comprises an indication of one or more dropped LCM functions.

8. The WTRU of claim 1, wherein the configuration information comprises configuration for measurement reporting, configuration for artificial intelligence/machine learning model monitoring, configuration for LCM function prioritization, or configuration for LCM function collision reporting.

9. The WTRU of claim 1, wherein the processor being configured to send the subset of measurement reports comprises the processor being configured to send one or more channel state information (CSI) measurements.

10. The WTRU of claim 1, wherein the processor is further configured to determine a priority order associated with the subset of the plurality of measurement reports, and wherein determining the priority of each LCM function is based on the determined priority order associated with the subset of the plurality of measurement reports.

11. A method performed by a wireless transmit/receive unit (WTRU), the method comprising:
receiving configuration information, wherein the configuration information indicates that the WTRU is to perform a plurality of life-cycle management (LCM) functions, wherein each LCM function of the plurality of LCM functions is associated with AI/ML functionality of one or more AI/ML models operated by the WTRU;
determining a plurality of measurement reports associated with a first reporting occasion based on the configuration information, wherein each measurement report of the plurality of measurement reports is associated with at least one LCM function of the plurality of LCM functions;
determining a priority of each LCM function of the plurality of LCM functions based on the configuration information;
determining a subset of the plurality of measurement reports to include in a transmission for the first reporting occasion based on the priority of each LCM function of the plurality of LCM functions; and
sending the subset of measurement reports in the transmission for the first reporting occasion.

12. The method of claim 11, wherein the plurality of LCM functions comprises any combination of inference, data collection, training, fine-tuning, performance monitoring, model transfer, model selection, model activation/deactivation, and model switching.

13. The method of claim 11, wherein determining the priority of each LCM functions is based on one or more rules, wherein the one or more rules comprises a measurement priority, a LCM function priority, or a number of processing units (PUs).

14. The method of claim 13, wherein the measurement priority is based on one or more of a measurement report type, a measurement report quantity, a serving cell index, or a report configuration, and wherein the LCM function priority comprises a weighted LCM function, a weighted model performance, or a weighted applicable condition.

15. The method of claim 11, wherein determining the subset of the plurality of measurement reports comprises dropping one or more measurements based on the determined priority of each LCM function and the configuration information.

16. The method of claim 11, further comprising sending a report that indicates artificial intelligence/machine learning capability of the WTRU.

17. The method of claim 11, further comprising transmitting a LCM collision report, wherein the LCM collision report comprises an indication of one or more dropped LCM functions.

18. The method of claim 11, wherein the configuration information comprises configuration for measurement reporting, configuration for artificial intelligence/machine learning model monitoring, configuration for LCM function prioritization, or configuration for LCM function collision reporting.

19. The method of claim 11, wherein send the subset of measurement reports comprises sending one or more channel state information (CSI) measurements.

20. The method of claim 11, further comprising determining a priority order associated with the subset of the plurality of measurement reports, and wherein determining the priority of each LCM function is based on the determined priority order associated with the subset of the plurality of measurement reports.
